(19) United States
(12) Patent Application Publication
(10) Pub. No.: US 2026/0117108 A1
(43) Pub. Date: Apr. 30, 2026

(54) ADDITIVE FOR THERMAL MANAGEMENT FLUID AND THERMAL MANAGEMENT FLUID COMPOSITION INCLUDING SAME

(71) Applicants: SK INNOVATION CO., LTD., Seoul (KR); SK ENMOVE CO., LTD., Seoul (KR)

(72) Inventors: Hong Won LEE, Daejeon (KR); Hak Mook KIM, Daejeon (KR); Kang Min JUNG, Daejeon (KR); Jung Nam KIM, Daejeon (KR); Sang Hye SHIN, Daejeon (KR); Kwang Kuk LEE, Daejeon (KR); Joo Hyun LEE, Daejeon (KR)

(21) Appl. No.: 19/372,272

(22) Filed: Oct. 29, 2025

(30) Foreign Application Priority Data
Oct. 30, 2024 (KR) 10-2024-0150970

(51) Int. Cl. C09K 5/10

(52) U.S. Cl. CPC C09K 5/10

(57) ABSTRACT

Disclosed are an additive for a thermal management fluid, the additive including a phosphate-based compound wherein the phosphate-based compound satisfies Chemical Formula 1, wherein the R groups in Chemical Formula 1 are each independently hydrogen or a functional group comprising 1 to 10 carbon atoms, and a thermal management fluid composition including the same.

### CROSS REFERENCE TO RELATED APPLICATION

The present application claims priority to Korean Patent Application No. 10-2024-0150970, filed Oct. 30, 2024, the entire content of which is incorporated herein for all purposes by this reference.

### BACKGROUND

### 1. Technical Field

The embodiments of the present disclosure relate generally to thermal management fluid technology and more particularly to an additive for a thermal management fluid and a thermal management fluid composition including the additive.

### 2. Description of the Related Art

Thermal management fluids are fluids used for efficient thermal transfer and control in cooling and heating systems.

Coolants serve to reduce the temperature of a heat source by absorbing heat generated from the pyrogen. A substance that exhibits high thermal efficiency, low viscosity, low cost, non-toxicity, and chemical stability while not causing corrosion of devices is desirable as a coolant.

With the performance enhancement of various electronics, such as electric vehicles, these electronics generate more and more heat during use. To facilitate product use and prevent shortened product life, control of the heat generated in such products must be taken into account.

Immersion cooling is one of the cooling methods used for thermal management of electronic devices and computer systems. Immersion cooling allows an electronic device to make direct contact with fluids for cooling and thus is capable of effective heat removal compared to existing air cooling or water cooling methods.

### SUMMARY

The embodiments of the present disclosure relate to an additive for a thermal management fluid and a thermal management fluid composition including the same.

One embodiment of the present disclosure provides an additive for a thermal management fluid, the additive including a phosphate-based compound.

According to an embodiment, the phosphate-based compound satisfies the Chemical Formula 1 below,

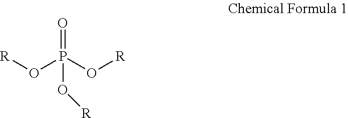

wherein the R groups are each independently hydrogen or a functional group comprising 1 to 10 carbon atoms.

According to an embodiment, at least one of the R groups is the functional group comprising 1 to 10 carbon atoms.

According to an embodiment, the R groups are each independently a functional group comprising 1 to 6 carbon atoms.

According to an embodiment, the R groups further comprise a heteroatom.

According to an embodiment, the heteroatom is a halogen atom.

According to an embodiment, the additive satisfies ΔFP of at least 10° C., and wherein ΔFP=(a flash point of a fluid including the additive)−(a flash point of a fluid free of the additive).

Another embodiment of the present disclosure provides a thermal management fluid composition including a base oil, and one or more phosphate-based compounds.

According to an embodiment, the composition is usable for immersion cooling.

According to an embodiment, the base oil is a mineral oil.

According to an embodiment, the base oil has a content of at least 80 wt % based on the total weight of the thermal management fluid composition.

According to an embodiment, the phosphate-based compound has a content of more than 0 wt % and 10 wt % or less based on the total weight of the thermal management fluid composition.

According to an embodiment, the composition further includes an additive.

According to an embodiment, the additive includes an antioxidant, an antifoaming agent, a corrosion inhibitor, a detergent additive, a dispersant, a friction modifier, an anti-wear agent, an extreme pressure additive, a viscosity index improver, a pour point depressant, a viscosity modifier, or a combination thereof.

According to an embodiment, the application of the additive can improve the safety of a thermal management fluid. According to an embodiment, the application of the additive can contribute to reducing the viscosity of a thermal management fluid. According to an embodiment, the application of the additive does not deteriorate the dielectric constant of a thermal management fluid. According to an embodiment, a thermal management fluid to which the additive is applied is usable as an immersion cooling fluid. According to an embodiment, the application of the additive can reduce the amount of power used for cooling because the cooling efficiency can be improved during immersion cooling using a thermal management fluid. As a result, there may be an expectation that carbon emissions can be reduced.

Another embodiment of the present disclosure provides a thermal management fluid composition comprising at least 80% by weight of a mineral oil based on the total weight of the thermal management fluid composition; and one or more phosphate-based compounds; wherein the flash point of the thermal management fluid composition is in the range of 190° C. to 250° C., and wherein one or more phosphate-based compounds are one or more of the following P1 to P5 compounds,

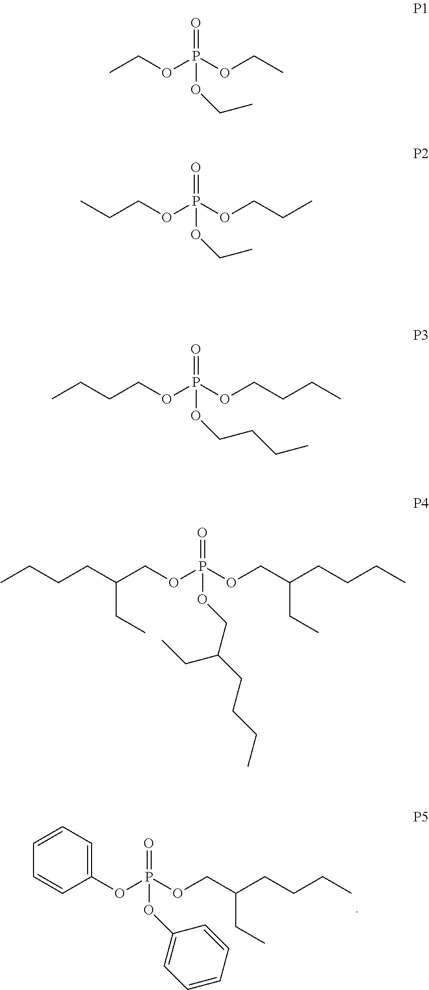

According to an embodiment, the mineral oil includes base oils corresponding to at least one of the Groups I to III according to the American Petroleum Institute (API) classification.

### BRIEF DESCRIPTION OF THE DRAWINGS

FIG. 1 illustrates structural formulas of phosphate-based compounds according to an embodiment of the present disclosure.

### DETAILED DESCRIPTION

Hereinafter, the embodiments of the present disclosure will be described in detail. However, this is only for illustrative purposes, and the embodiments are not limited to the specific embodiments illustrated below.

### Additive for Thermal Management Fluid

The embodiments of the present disclosure provide an additive for a thermal management fluid. The additive includes a phosphate-based compound. Hence, the “additive for a thermal management fluid” in the present disclosure may be used interchangeably with a “phosphate-based additive” or “phosphate-based compound additive”. In the present disclosure, the phosphate-based compound refers to a phosphate-containing compound. Specifically, the phosphate-based compound may be an organic phosphate compound. In an embodiment, the additive for a thermal management fluid may be a phosphate-based compound. In another embodiment, the additive for a thermal management fluid may include one or more phosphate-based compounds.

The phosphate-based compound may satisfy Chemical Formula 1 below.

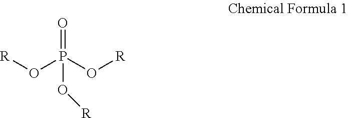

In this case, the three R groups are independent of each other. The R groups may be hydrogen or a functional group having 1 to 10 carbon atoms. Specifically, the R groups may be hydrogen or a functional group having 1 to 8 carbon atoms. More specifically, the R groups may be hydrogen or a functional group having 1 to 6 carbon atoms. From the viewpoint of a higher flash point, the number of carbon atoms in the R groups may be less than 8, or equal to or less than 6.

According to an embodiment, at least one of the three R groups may not be hydrogen. That is, at least one of the R groups may be the functional group having 1 to 10 carbon atoms. Specifically, at least two of the R groups may not be hydrogen but functional groups. More specifically, the R groups may not be hydrogen, but all may be functional groups. In this case, the three R groups may be independent of each other as well. Even more specifically, the R groups may be each independently a functional group having 1 to 6 carbon atoms. From the viewpoint of improvement in the performance of a thermal management fluid, including the additive, each of the R groups may be functional groups, none of which is hydrogen. Specifically, the improvement in the performance may involve improvements in flame retardancy, electrical conductivity, corrosiveness, and the like.

According to an embodiment, the total number of carbon atoms in the compound may be in the range of 1 to 30. Specifically, the total number of carbon atoms may be in the range of 1 to 24, more specifically 1 or more and less than 24, even more specifically in the range of 1 to 21, and far more specifically in the range of 1 to 18. From the viewpoint of a higher flash point, the total number of carbon atoms may be less than 24, or less than or equal to 21.

For example, the functional group may be a hydrocarbyl group. From the viewpoint of chemical stability, the functional group may be an alkyl group. The functional group may be straight-chain, branched-chain, or cyclic. Alternatively, the functional group may include an aromatic.

According to another embodiment, the R groups may further include a heteroatom. For example, the R groups may further include O, N, S, P, B, F, Cl, Br, I, or a combination thereof. Specifically, the R groups may further include a halogen atom. In this case, the R group may be a halogen atom-substituted alkyl group. More specifically, the R groups may further include F.

The use of the additive in a thermal management fluid may increase the flash point of the fluid. While not wishing to be bound by any particular theory, the phosphate-based compound in the additive may remove radicals and form char layers. In addition, when added to a thermal management fluid for use, it is considered that the phosphate-based compound removes combustible radicals generated by the oxidation of base oil, thus increasing the flash point.

According to an embodiment, the additive may satisfy ΔFP of at least 10° C. In this case, ΔFP means (the flash point of a fluid including the additive)−(the flash point of a fluid free of the additive). In the present disclosure, the flash point of the fluid is measured according to ASTM D93. The ΔFP value refers to the maximum ΔFP value when the amount of the additive included in the fluid is in the range of more than 0 wt % and 10 wt % or less. Specifically, the ΔFP may be in the range of 10 to 60, more specifically in the range of 15 to 60, and even more specifically in the range of 15 to 55.

Hence, ΔFP refers to the change in flash point caused by adding the additive to the fluid. It's calculated as the difference between the FP of the fluid with the additive and the FP of the fluid without the additive. So, for example, if the fluid originally has a flash point of 50° C. and after adding the additive the FP rises to 65° C., then the ΔFP=15° C.

The additive of the present disclosure may increase the flash point by at least 10° C., and, thus, enhances significantly the fluid's safety by making it less prone to ignition at lower temperatures.

The additive described above may increase the flash point of a thermal management fluid, which may in turn significantly improve safety, for example, by delaying thermal runaway, and can be achieved in systems where such a fluid is used. In addition, the additive enables the use of base oils in thermal management fluids which without the additive would have been unsuitable for such use. Hence, the additive of the present disclosure allows expanding the selectivity of base oils for use in thermal management fluids.

### Thermal Management Fluid Composition

The embodiments of the present disclosure provide a thermal management fluid composition including the aforementioned additive, that is, a phosphate-based additive, for a thermal management fluid. Hereinafter, it should be noted that the foregoing description is applicable in terms of the additive for a thermal management fluid, and redundant descriptions may be omitted. The thermal management fluid composition has excellent physical properties such as insulation and cooling performance, and thus is capable of cooling electronic devices by making direct contact with such devices. That is, the composition is usable as an immersion cooling fluid. For example, the fluid can safely surround and cool components like CPUs and GPUs without causing electrical shorts, making it ideal for high-performance systems where traditional air cooling may fall short.

The composition includes a base oil and one or more phosphate-based compounds. The base oil may include a mineral oil, a synthetic oil, or a combination thereof. The mineral oil refers to oil derived from crude oil without undergoing a separate synthetic process. In the present disclosure, the mineral oil may include base oils corresponding to at least one of the Groups I to III according to the American Petroleum Institute (API) classification. The synthetic base oil includes, for example, polyalphaolefin (PAO) or ester base oil. In an embodiment, the base oil may include the mineral oil as the major base oil and the synthetic base oil as the minor base oil. In the present disclosure, the major base oil refers to a base oil the content of which exceeds 50 wt % of the total base oil content. In another embodiment, the base oil may be the mineral oil.

PAO exhibits superior performance compared to mineral oil, but is expensive, which may be disadvantageous.

By including the aforementioned phosphate-based additive, the composition of the present disclosure may achieve at least equivalent performance as a thermal management fluid despite using the mineral oil as the base oil, compared to when using only PAO. In addition, there may be an expectation that a relatively inexpensive price can be achieved. Although ester base oils may have excellent thermal conductivity, they are polar, so their insulation performance is poorer than that of the mineral oil, and is vulnerable to moisture due to the possibility of hydrolysis. Thus, ester base oils are inappropriate for use as the major base oil in the present disclosure.

According to an embodiment, the base oil may have a content of at least 80 wt % with respect to the total weight of the composition. Specifically, the content of the base oil may be 80 wt % or more and less than 100 wt %. More specifically, the content of the base oil may be 90 wt % or more and less than 100 wt %. Even more specifically, the content of the base oil may be in the range of 90 to 98 wt %.

When the content of the base oil is low, the amount of the additive used, which is significantly more expensive compared to the base oil, may increase, leading to a problem where the price of the final product increases significantly. In addition, the dielectric constant of the final product may increase, leading to an increase in electrical conductivity and deterioration in material compatibility (such as corrosion). As a result, there may be a problem where the use of the composition as an immersion cooling fluid becomes challenging.

The base oil of the present disclosure may not be particularly limited as long as it is usable as the thermal management fluid or immersion cooling fluid. Furthermore, the addition of the phosphate-based compound may increase the flash point of such a fluid, so it is considered that oils having a lower flash point than base oils used in existing thermal management fluids are usable as novel base oils.

The composition includes the one or more phosphate-based compounds. The one or more phosphate-based compounds may be the aforementioned compound of Chemical Formula 1.

According to an embodiment, the phosphate-based compound may have a content of more than 0 wt % and 10 wt % or less with respect to the total weight of the composition. For example, the content of the phosphate-based compound may be in the range of 0.1 to 10 wt %, 0.5 to 10 wt %, 1 to 10 wt %, 2 to 10 wt %, 3 to 10 wt %, 4 to 10 wt %, 5 to 10 wt %, 0.1 to 9 wt %, 0.5 to 9 wt %, 1 to 9 wt %, 2 to 9 wt %, 3 to 9 wt %, 4 to 9 wt %, 5 to 9 wt %, 0.1 to 8 wt %, 0.5 to 8 wt %, 1 to 8 wt %, 2 to 8 wt %, 3 to 8 wt %, 4 to 8 wt %, 5 to 8 wt %, 0.1 to 7 wt %, 0.5 to 7 wt %, 1 to 7 wt %, 2 to 7 wt %, 3 to 7 wt %, 4 to 7 wt %, 5 to 7 wt %, 0.1 to 6 wt %, 0.5 to 6 wt %, 1 to 6 wt %, 2 to 6 wt %, 3 to 6 wt %, 4 to 6 wt %, or 5 to 6 wt %. Specifically, the content of the phosphate-based compound may be in the range of 1.5 to 10 wt %. From the viewpoint of increasing the flash point, the content of the phosphate-based compound may be at least 1.5 wt %. When the content of the phosphate-based compound exceeds the aforementioned numerical values, there may be a problem in that the flash point of the composition becomes lower than the flash point of a thermal management fluid composition free of the phosphate-based compound. A lower flash point means the fluid can ignite at lower temperatures, raising the likelihood of fire hazards during operation or storage.

The composition may further include another additive in addition to the phosphate-based compound. In this case, this additional additive may refer to an additive that differs from the additive for a thermal management fluid discussed above and may also be referred to as a “second additive” in the present disclosure for the purpose of distinction.

The second additive may not be particularly limited as long as it is usable to improve the physical properties of the thermal management fluid. For example, the second additive may include an antioxidant, an antifoaming agent, a corrosion inhibitor, a detergent additive, a dispersant, a friction modifier, an anti-wear agent, an extreme pressure additive, a viscosity index improver, a pour point depressant, a viscosity modifier, or any combination thereof.

In an embodiment, the second additive may have a total content in the range of 0 to 10 wt % with respect to the total weight of the composition. For example, the content of the second additive may be in the range of 0.01 to 10 wt %, 0.05 to 10 wt %, 0.1 to 10 wt %, 0.2 to 10 wt %, 0.5 to 10 wt %, 1 to 10 wt %, 0.01 to 7 wt %, 0.05 to 7 wt %, 0.1 to 7 wt %, 0.2 to 7 wt %, 0.5 to 7 wt %, 1 to 7 wt %, 0.01 to 5 wt %, 0.05 to 5 wt %, 0.1 to 5 wt %, 0.2 to 5 wt %, 0.5 to 5 wt %, or 1 to wt %. Specifically, in an embodiment, the content of the second additive may be in the range of 0 to 5 wt %.

As described above, the flash point of the fluid composition is increased by the addition 5 of the phosphate-based compound. Specifically, the flash point of the fluid composition, including the phosphate-based compound, may be higher than that of a composition free of the phosphate-based compound by at least 10° C. More specifically, such a difference in flash point may be in the range of 10° C. to 60° C., more specifically in the range of 15° C. to 60° C., and even more specifically in the range of 15° C. to 55° C. In the present disclosure, the flash point is measured according to ASTM D93.

According to an embodiment, the flash point of the composition with the phosphate-based compound may be at least 190° C., or in the range of 190° C. to 250° C., or in the range of 195° C. to 250° C.

The kinematic viscosity of the fluid composition may be reduced by the addition of the phosphate-based compound. For example, the kinematic viscosity (at 40° C.) of the fluid composition including the phosphate-based compound may be reduced by at least 1 cSt. More specifically, the kinematic viscosity may be reduced by at least 1.5 cSt.

As described above, the use of the phosphate-based compound additive in a thermal fluid composition for a thermal management fluid according to the present disclosure increases the flash point of the fluid, thus leading to improved safety. For example, the thermal management fluid may delay a thermal runaway when used in immersion cooling and other systems. In addition, the use of the phosphate-based additive may reduce the viscosity of the fluid compared to a base oil, leading to reduced power consumption when applied to immersion cooling and other systems. The phosphate based compound additive may be used with existing thermal management fluids and thus may be used for various purposes.

Hereinafter, embodiments of the present disclosure will be further described with reference to specific experimental examples. However, the examples and comparative examples contained in the experimental examples are only provided for illustrating the embodiments of the present disclosure and are not intended to limit the scope of the embodiments as define the appended claims. It should be apparent to those skilled in the art that various changes and modifications of the embodiments are possible within the scope and technical concepts of the present disclosure, and such changes and modifications fall within the scope of the appended claims. Furthermore, the embodiments may be combined to form additional embodiments.

### Example

### 1. Preparation of Phosphate-Based Compounds

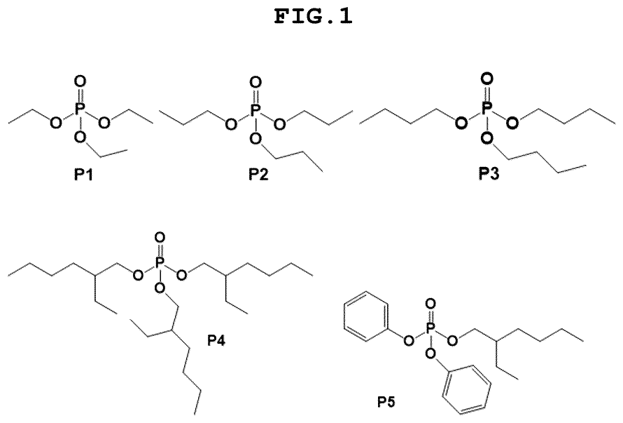

Phosphate-based compounds (P1 to P5) to be used in the following experiment were prepared. The specific chemical structure of each compound is as shown in FIG. 1.
P1: Triethyl phosphate (TCI)
P2: Tripropyl phosphate (Sigma Aldrich)
P3: Tributyl phosphate (Samchun Chemicals)
P4: Tris(2-ethylhexyl) phosphate (TCI)
P5: 2-ethylhexyl diphenyl phosphate (TCI)
   2. Observation of Changes in Physical Properties with Addition of Phosphate-Based

### Compounds

Two types of base oil (Base oil A (YUBASE 3, SK Enmove) and Base oil B (YUBASE 6, SK Enmove)) were prepared. A specific amount of Compound P1 or P2 was added to each type of base oils A and B to observe changes in the physical properties with the addition of the compound. The respective physical properties were measured using the following equipment and/or methods.
Closed-cup flash point: ASTM D93 Method
Electrical conductivity: Flucon's Epsilon+/IEC 60247
Kinematic viscosity: Cannon's CAV2000/ASTM D445-01

The measurement results are shown in Table 1 below.

TABLE 1

| | | | | Kinematic | Electrical |
|---|---|---|---|---|---|
| | Base | Additive, | Closed-cup | viscosity (at | conductivity |
| Composition | oil | Content | flash point (° C.) | 40° C., cSt) | (at 40° C., nS/m) |
| C1 | A | — | 184 | 12.0 | <0.01 |
| C2 | B | — | 221 | 35.16 | <0.01 |
| 1 | A | P1, 2.5 wt % | 208 | 10.92 | <0.01 |
| 2 | A | P1, 5 wt % | 198.5 | 10.08 | <0.01 |
| 3 | A | P2, 5 wt % | 222.5 | 10.47 | <0.01 |
| 4 | B | P2, 5 wt % | 231.5 | 28.54 | <0.01 |

Referring to Table 1, it is seen that the addition of the phosphate-based compound of the present disclosure still maintains the electrical conductivity while increasing the flash point and reducing the kinematic viscosity. From the viewpoint that such a reduction in kinematic viscosity can reduce the power consumption of a pump required for fluid to flow, there may be a beneficial effect provided.

### 3. Observation of Changes in Flash Point Depending on the Amount of Phosphate-Based Compound Added

### (1) Base Oil A

Different contents of P1 to P5 were added to Base oil A to observe changes in flash point depending on the amounts of the compounds added. The measurement results are shown in Table 2 below.

TABLE 2

| Composition | Additive | Content | | Flash point (° C.) | Delta Δ |
|---|---|---|---|---|---|
| AC1 | — | — | | 184 | 0 |
| A1 | P1 | 2.5 | wt % | 208 | 24 |
| A2 | P1 | 5 | wt % | 198.5 | 14.5 |
| A3 | P2 | 2.5 | wt % | 223.5 | 39.5 |
| A4 | P2 | 5 | wt % | 222.5 | 38.5 |
| A5 | P3 | 5 | wt % | 231.5 | 47.5 |
| A6 | P3 | 10 | wt % | 235 | 51 |
| AC2 | P4 | 2.5 | wt % | 187 | 3 |
| AC3 | P4 | 5 | wt % | 187.5 | 3.5 |
| AC4 | P5 | 5 | wt % | 190 | 6 |

### (2) Base Oil B

Different contents of P2 and P3 were added to Base oil B to observe changes in flash point depending on the amounts of the compounds added. The measurement results are shown in Table 3 below.

TABLE 3

| Composition | Additive | Content | | Flash point (° C.) | Delta Δ |
|---|---|---|---|---|---|
| BC1 | — | — | | 221 | 0 |
| B1 | P3 | 2.5 | wt % | 240 | 19 |
| B2 | P3 | 5 | wt % | 230 | 9 |
| B3 | P3 | 10 | wt % | 230 | 9 |
| B4 | P2 | 2.5 | wt % | 241.5 | 20.5 |
| B5 | P2 | 5 | wt % | 231.5 | 10.5 |

Referring to Tables 2 and 3, it is seen that the flash point becomes higher than that of existing base oils by the addition of the phosphate-based compounds of the present disclosure. Especially in the case of P1 to P3, it is seen that the flash point increases by 9° C. or more.

In addition, referring to Table 3, it is seen that the addition of the additive of the present disclosure can provide an effect of increasing the flash point even for base oils having a high flash point of 200° C. or more.

Referring back to Tables 2 and 3, it is seen that the content of the additive having the maximum ΔFP value may differ for each additive. While not wishing to be bound by any particular theory, it is considered that the maximum ΔFP value is affected by the lower flammability limit (LFL) of the additive.

As confirmed from the above examples, the phosphate-based compound of the present disclosure is capable of being used as an additive for a thermal management fluid and thus being utilized in various fields by improving various physical properties of the fluid.

The above examples and embodiments are merely provided for illustrating the principles of the present disclosure with specific examples, however, it should be understood that other embodiments may be further envisioned by those with ordinary skill in the art without departing from the scope of the present disclosure.

What is claimed is:

1. An additive for a thermal management fluid, the additive comprising:
a phosphate-based compound.

2. The additive according to claim 1, wherein the phosphate-based compound satisfies Chemical Formula 1 below, 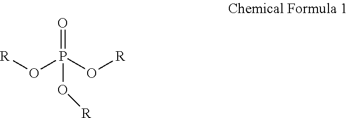
wherein the R groups are each independently hydrogen or a functional group comprising 1 to 10 carbon atoms.

3. The additive according to claim 2, wherein at least one of the R groups is a functional group comprising 1 to 10 carbon atoms.

4. The additive according to claim 2, wherein the R groups are each independently a functional group comprising 1 to 6 carbon atoms.

5. The additive according to claim 2, wherein the R groups further comprise a heteroatom.

6. The additive according to claim 5, wherein the heteroatom is a halogen atom.

7. The additive according to claim 1, wherein the additive satisfies ΔFP of at least 10° C., and
wherein ΔFP=(a flash point of a fluid comprising the additive)−(a flash point of a fluid free of the additive).

8. A thermal management fluid composition comprising:
a base oil; and
one or more phosphate-based compounds.

9. The composition according to claim 8, wherein the composition is usable for immersion cooling.

10. The composition according to claim 8, wherein the base oil is a mineral oil.

11. The composition according to claim 8, wherein the base oil has a content of at least 80 wt % based on the total weight of the thermal management fluid composition.

12. The composition according to claim 8, wherein the phosphate-based compound has a content of more than 0 wt % and 10 wt % or less based on the total weight of the thermal management fluid composition.

13. The composition according to claim 8, wherein the composition further comprises an additive.

14. The composition according to claim 13, wherein the additive comprises an antioxidant, an antifoaming agent, a corrosion inhibitor, a detergent additive, a dispersant, a friction modifier, an anti-wear agent, an extreme pressure additive, a viscosity index improver, a pour point depressant, a viscosity modifier, or a combination thereof.

15. A thermal management fluid composition comprising:
at least 80% by weight of a mineral oil based on the total weight of the thermal management fluid composition; and
one or more phosphate-based compounds;
wherein the flash point of the thermal management fluid composition is in the range of 190° C. to 250° C.,
and wherein one or more phosphate-based compounds are one or more of the following P1 to P5 compounds,

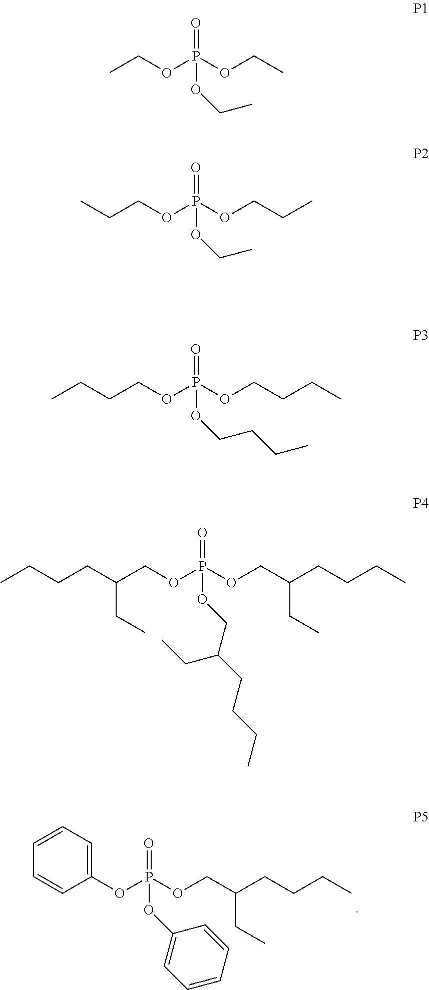

16. The composition of claim 15, wherein the mineral oil includes base oils corresponding to at least one of the Groups I to III according to the American Petroleum Institute (API) classification.
